(19) United States
(12) Patent Application Publication
(10) Pub. No.: US 2016/0104262 A1
(43) Pub. Date: Apr. 14, 2016

(54) INTELLIGENT CARE FACILITY SELECTION ADVISOR

(71) Applicant: STEVEN D. KUKER, SPRING HILL, KS (US)

(72) Inventor: STEVEN D. KUKER, SPRING HILL, KS (US)

(21) Appl. No.: 14/511,391

(22) Filed: Oct. 10, 2014

(51) Int. Cl. G06Q 50/22; G06Q 10/10; G06F 17/30

(52) U.S. Cl. CPC G06Q 50/22; G06F 17/30554; G06F 17/30867; G06F 17/30528; G06Q 10/10

(57) ABSTRACT

Methods, computer systems, and computer-storage media are provided for creating a guided care facility selection service. The service presents care facility selection options to a user, receives selections from the user and accesses a data store to extract selection meeting the user selections. A results display is used to communicate the matching selections to the user.

### BACKGROUND

As our society ages, it often becomes the case that a loved-one needs to be placed in some type of care facility. The process can be overwhelming to those involved, and is often incredibly time-consuming and confusing. Those needing the care may not be in a position to make the decision themselves. Those helping in the decision process, such as children, spouses or other loved ones, are confronted with terminology, payment systems, and care-types that are largely unknown to them. Adding to the problem, the decisions may need to be made on an expedited basis. Because the decision directly affects the quality of life of the loved one, it is loaded with emotion. Therefore, a system is needed to provide a guided experience for people facing the selection of a care facility that educates, informs and presents applicable options to narrow the selection options to a manageable level, and to provide further guidance among the remaining options.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, creating a selection system to guide users through a process for narrowing possible options for a care facility. The selection system presents users with a guided selection allowing the user to select an applicable facility type, level of care, payment method and desired location. As the user navigates the guided selection, educational material is provided to ensure the user understands the terminology presented. Additionally, inapplicable options are eliminated from possible selection to provide clarity to the user. The system transforms the user selections into a list of facilities for further consideration by the user. The list of facilities includes contact information, basic facility information, advanced facility information, and a guide of further information to consider. The system thus greatly simplifies the process for the user, and provides them information and confidence as they navigate the selection process.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for the guided care facility selection system, suitable for use in implementing embodiments of the present invention;

FIG. 3 is an exemplary screen display illustrating a possible input screen generated by the guided care facility selection service, in accordance with an embodiment of the present invention;

FIG. 4 is a view similar to FIG. 3, showing an exemplary education pop-up;

FIG. 5 is an exemplary results display generated by the guided care facility selection system;

FIG. 6 is an exemplary results display showing a mapping of results generated by the guided care facility selection system; and

FIG. 7 is a flow diagram illustrating the method of guided care facility selection service, according to embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, creating a selection system to guide users through a process for narrowing possible options for a care facility. The selection system presents users with a guided selection allowing the user to select an applicable facility type, level of care, payment method and desired location. As the user navigates the guided selection, educational material is provided to ensure the user understands the terminology presented. Additionally, inapplicable options are eliminated from possible selection to provide clarity to the user. The system transforms the user selections into a list of services and/or facilities for further consideration by the user. The list of facilities includes, for example, contact information, basic facility information, advanced facility information, and a guide of further information to consider, including future questions and other users' ratings of any facilities. The system thus greatly simplifies the process for the user, and provides them information and confidence as they navigate the selection process.

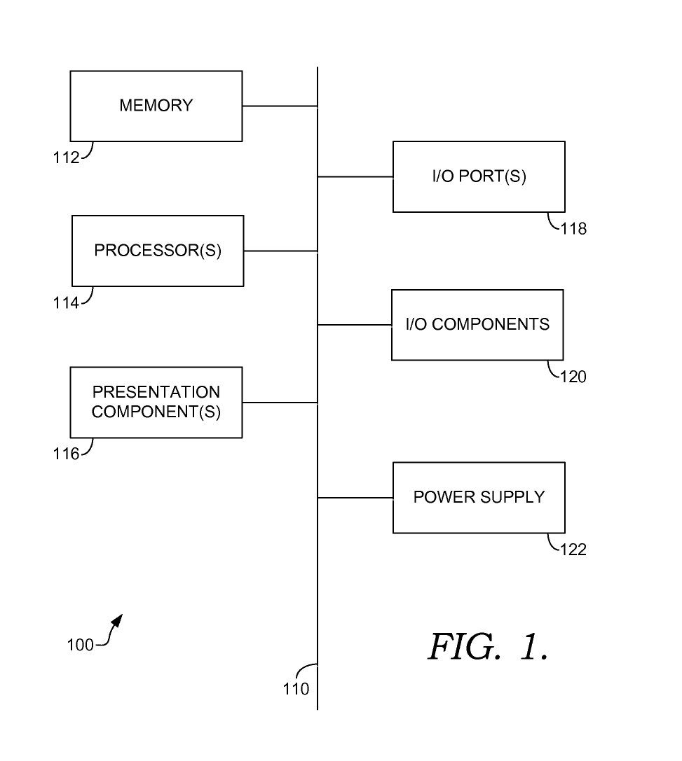

Having briefly described an overview, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant, a smart phone, a tablet PC, or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a scanner, printer, wireless device, and the like.

Furthermore, although the term “server” is often used herein, it will be recognized that this term may also encompass a Web browser, a cloud server, a set of one or more processes distributed on one or more computers, one or more stand-alone storage devices, a set of one or more other computing or storage devices, a combination of one or more of the above, and the like.

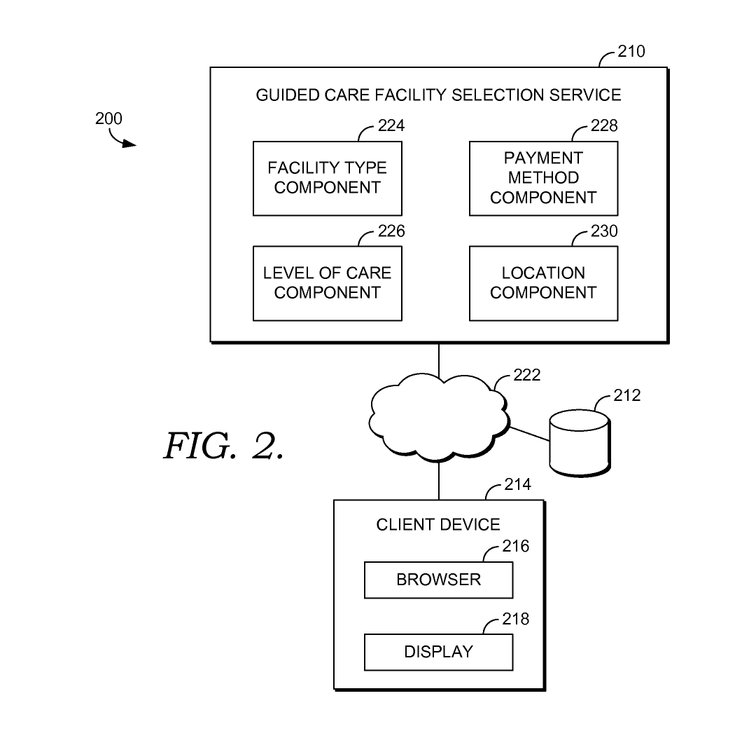

Referring now to FIG. 2, a block diagram is provided illustrating an exemplary computing system 200 in which embodiments of the present invention may be employed. Generally, the computing system 200 illustrates an environment in which users are able to participate in a guided care facility selection.

Among other components not shown, the computing system 200 generally includes a guided care facility selection service 210, a data store 212, and a client device 214 all in communication with one another via a network 222. The network 222 may include, without limitation, one or more local area networks (LANs) and/or wide area networks (WANs). Such networking environments are commonplace in offices, enterprise-wide computer networks, intranets and the Internet. Accordingly, the network 222 is not further described herein.

It should be understood that any number of client computing devices and advertisement distribution services may be employed in the computing system 200 within the scope of embodiments of the present invention. Each may comprise a single device/interface or multiple devices/interfaces cooperating in a distributed environment. For instance, the guided care facility selection service 210 may comprise multiple devices and/or modules arranged in a distributed environment that collectively provide the functionality of the guided care facility selection service 210 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the client device 214, as an Internet-based service, as a third-party application service, or as a module inside the guided care facility selection service 210. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search services, third-party applications, or client computing devices. By way of example only, the guided care facility selection service 210 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The client computing device 214 may include any type of computing device, such as the computing device 100 described with reference to FIG. 1, for example. Generally, the client computing device 214 may include a browser 216 and a display 218. The browser 216, among other things, is configured to render selection pages, informational “pop-ups”, selection result options and maps, and the like in association with the display 218 of the client computing device 214. The browser 216 is further configured to receive user input of selected options, receive user-inputted queries about options (generally inputted via a user “hovering” over an option on the display 218), and to receive content for presentation on the display 218, for instance, from the guided care facility selection service 210. The browser 216 may be any suitable type of Web browser such as Internet Explorer®, Firefox®, Chrome®, Safari®, or other type of software similarly configured. It should be noted that the functionality described herein as being performed by the browser 216 may be performed by any other application capable of rendering Web content, or that the functionality may be performed solely on a “stand-alone” device as described above. Any and all such variations, and any combination thereof, are contemplated to be within the scope of embodiments of the present invention.

The display 218 is configured to present various content including, without limitation, a welcome informational page, a care facility selection page(s) and results pages, as described herein. In embodiments, the display 218 is further configured to enable touch inputs, auditory inputs, and/or gesture inputs from a user.

The guided care facility selection service 210 is configured to receive and respond to requests and/or communications that it receives from components associated with client computing devices. As illustrated, the guided care facility selection service 210 includes a facility type component 224, a level of care component 226, a payment method component 228, and a location component 230. In some embodiments, one or more of the components 224, 226, 228, and 230 may be implemented as stand-alone applications. In other embodiments, one or more of the components 224, 226, 228, and 230 may be integrated directly into the system of a computing device such as the computing device 100 of FIG. 1 or the client device 214. It will be understood that the components 224, 226, 228, and 230 illustrated in FIG. 2 are exemplary in nature and in number and should not be construed as limiting. Any number of components may be employed to achieve the desired functionality within the scope of embodiments hereof.

The illustrated guided care facility selection service 210 also has access to the data store 212. The data store 212 is configured to store information for use by, for example, the guided care facility selection service 210. The information stored in association with the data store 212 is configured to be searchable for one or more items of information stored in association therewith. The information stored in association with the data store 212 may comprise facility information used by the guided care facility selection service 210. For example, the data store 212 may store information concerning facility types, levels of care, payment options and locations. Facility information may also comprise additional information, such as the number of residents, the Medicare rating, contact information, ownership information, and the like.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the guided care facility selection service 210, the client device 214, and/or any combination thereof.

The components 224, 226, 228 and 230 of the guided care facility selection service 210 are configured to access data store 212 with user selections, structured to correspond with the data store, and to extract information according to user selections. More specifically, each component 224, 226, 228 and 230 of the guided care facility selection service 210 is configured to present available options to a user on display 218, receive user selections input on client device 214, access data store 212, and determine options that, in one aspect, meet at least a portion of the parameters specified in the user selection process.

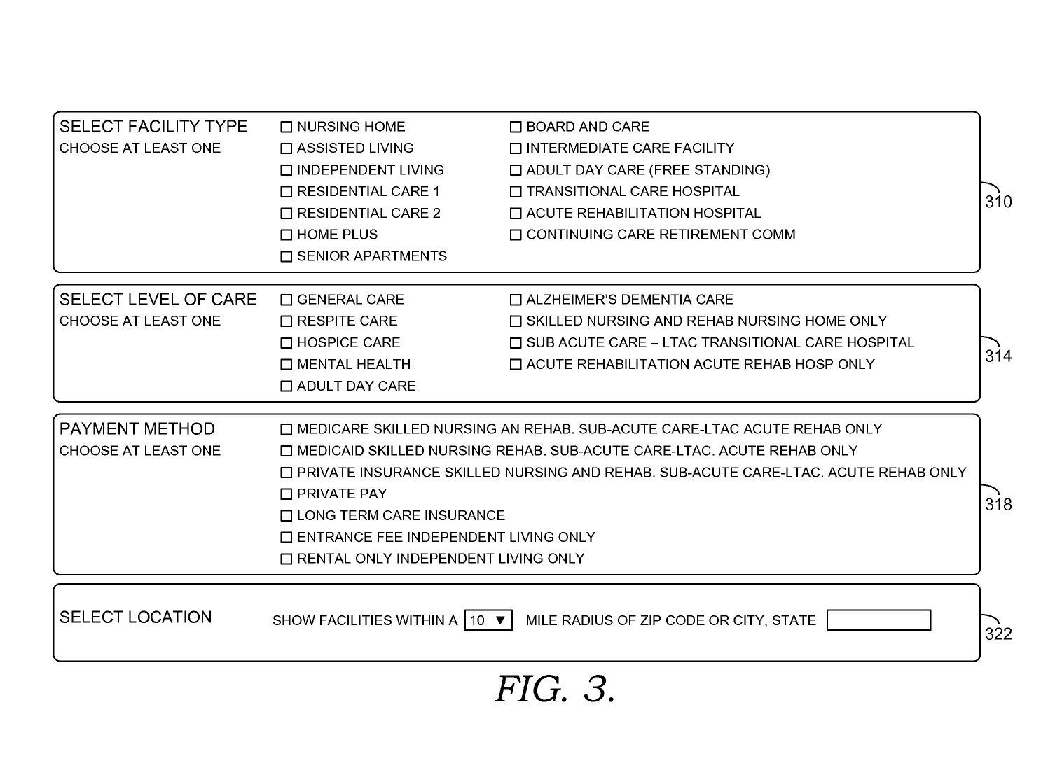

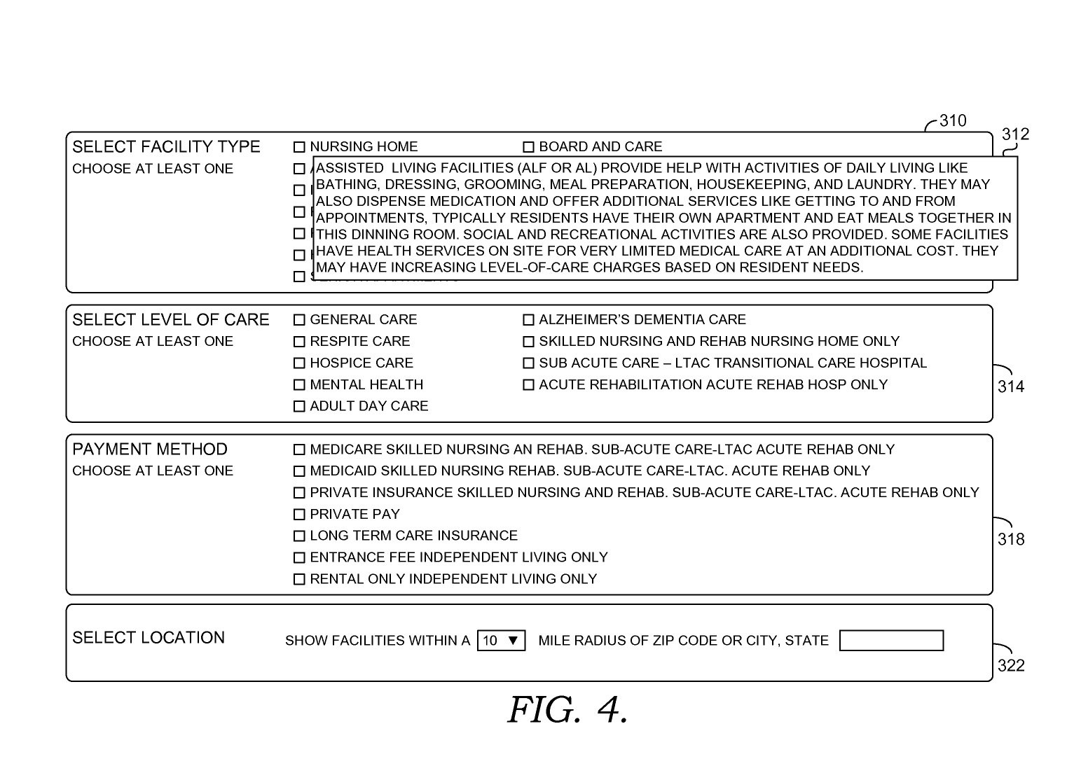

FIG. 3 is an example of a display generated by guided care facility selection service 210, and specifically components 224, 226, 228 and 230. Display area 310 presents a user some type of selection list of available care facility types, generated by facility type component 224 using data from data store 212. The user is allowed to select one or more facility types that may be of interest to the user. Each facility type has an associated definitional “pop-up”, an example of which is shown at 312, (FIG. 4) that can educate or inform a user about each particular facility type. The information needed to generate the pop-up can be retrieved from data store 212, or it may be stored within facility type component 224. The pop-up 312 can be generated if a user “hovers” over a particular facility type, or selects it in some other way. Exemplary facility types include those listed in display area 310, including Nursing Home, Assisted Living, Independent Living, Residential Care 1, Residential Care 2, Home Plus, Senior Apartments, Board and Care, Intermediate Care Facility, Adult Day Care, Transitional Care Hospital, Acute Rehabilitation Hospital and Continuing Care Retirement Community, but other facility types could of course be shown, if available.

Similarly, a display area 314 presents a user some type of selection list of available levels of care, generated by level of care component 226 using data from data store 212. The user is allowed to select one or more levels of care that may be of interest to the user. Each level of care also has an associated definitional “pop-up”, similar in nature to the pop-up 312 (with different content) that can educate or inform a user about each different level of care. The information needed to generate the pop-up can be retrieved from data store 212, or it may be stored within facility type component 224. Exemplary levels of care include those listed in display area 314, including General Care, Respite Care, Hospice Care, Mental Health, Adult Day Care, Alzheimer's Dementia Care, Skill Nursing and Rehab, Sub Acute Care, and Acute Rehabilitation, but other levels of care could of course be shown, if available.

An exemplary display area 318 presents a user a selection list of available payment methods, generated by payment method component 228 using data from data store 212. The user is allowed to select one or more payment methods that may be of applicable to the user. Each payment method also has an associated definitional “pop-up”, similar in nature to the pop-up 312 (with different content) that can educate or inform a user about the particular payment types and parameters involved. The information needed to generate the pop-up can be retrieved from data store 212, or it may be stored within facility type component 224. Exemplary payment types include those listed in display area 318, including Medicare, Medicaid, Private Insurance, Private Pay, Long Term Care Insurance, Entrance Fee and Rental Only, but other payment methods could of course be shown, if available.

Finally, a location display area 322 presents a user some type of selection list of a desired location for the facility, generated by location component 230 using data from data store 212. The user is allowed to select location parameters that define a location of interest to the user. For example, the location parameters may include facilities within a certain distance of a city or zip code. Other types of location selection may be used, such as within a city, or state.

For each display area 310, 314 and 318 a list of selectable check boxes is shown. Other types of selection are possible on display 218, such as drop-down lists, touch-screen icons, or any other display allowing selections from among possible options by a user. Additionally, the guided care facility selection service 210 provides an intelligent input selection to the user. More specifically, the service 210, or each component 224, 226, 228 and 230 will disallow selection possibilities when such selection possibilities are no longer available, based on previous user selections. As an example, and without limitation, if a user selects Assisted Living in display area 310, certain options are not available in the level of care display area 314, such as Skilled Nursing/Rehabilitation, Acute Rehabilitation and Sub-Acute Care. These options are displayed, but are not selectable by the user. As another example, if the user selects the General Care level in display area 314, then the system 210 will not allow the user to select Medicare, Medicaid, Private Insurance, Entrance Fee, or Rental Only as payment methods within display area 318. Through the display areas 310, 314, 318 and 322 the system 210 provides a guided selection process to a user. The system provides educational definitional pop-ups to inform users of the terminology and displays selectable options existing within data store 212, and further allows selections from users for only those options possible determined by a user's prior selection of options.

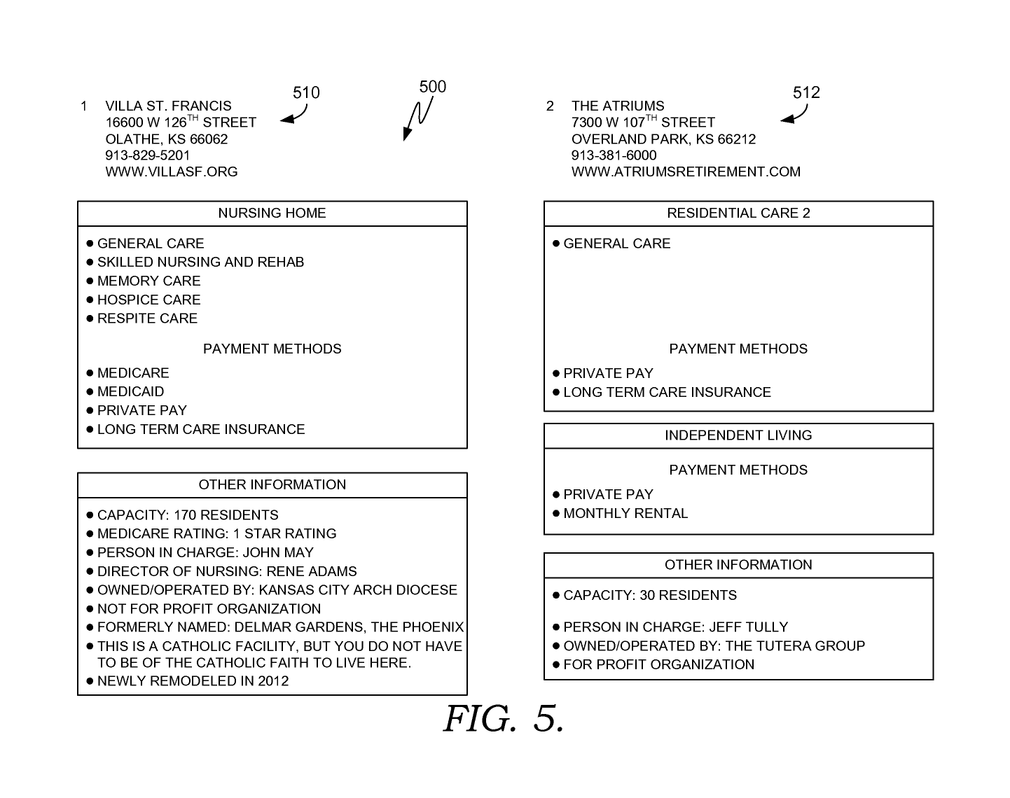

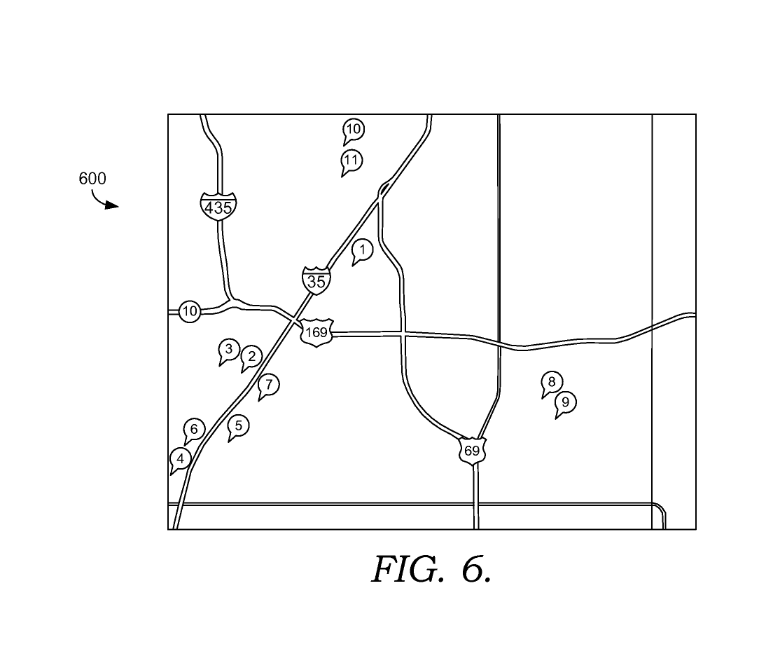

The system 210, through the components 224, 226, 228 and 230 receive the user selections. After receiving the user selections, the components 224, 226, 228 and 230 access the data store 212 with the user selections. The guided care facility selection service 210 determines care facilities meeting the criteria of the user's selections. Upon this determination, the service 210 presents the results to the user on display 218. An exemplary results display 500 is shown in FIG. 5. Display 500 includes facilities 510 and 512 meeting the selection criteria of the user. Along with basic facility information, such as the name, address, phone number and website, the display 500 includes other information as well. So, the results display 500 may include a listing of facilities, along with all information about the facility within data store 212. Additionally, a mapping display of the listed facilities may be presented to the user on display 218. An exemplary mapping display 600 is shown in FIG. 6. The numbers in the bubbles of mapping display 600 correspond to facilities listed in a display, such as display 500. As would be understood, both the listing of matching facilities and the mapping of facilities are easily saved in electronic form for use on any device, or printed by the user for future reference. Other information may also be displayed for the user, such as future questions to ask upon visiting a facility, ownership information about the facility, past performance issues and any other information existing, collected and stored within data store 212.

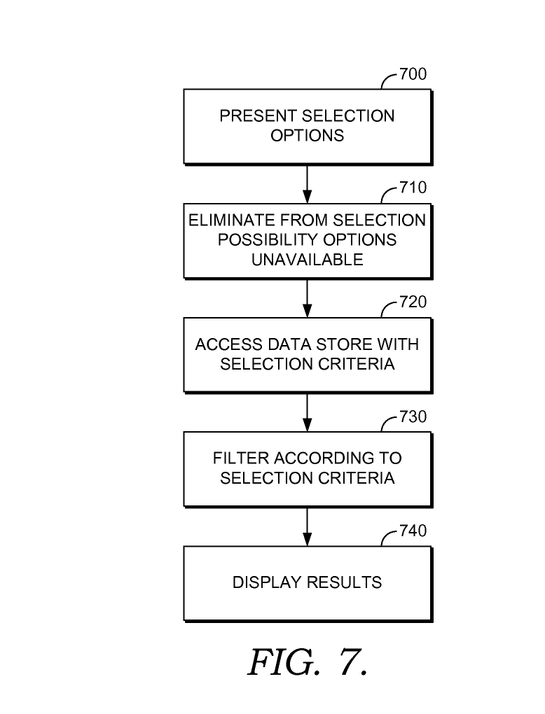

A method for providing a guided care facility selection process is shown in FIG. 7. As shown, the method begins at step 700 by presenting selection options to a user. The selection options of step 700 are those discussed above with respect to display areas 310, 314, 318 and 322. The method continues at step 710 by eliminating from selection possibility any option no longer available after initial selections by a user. After option selection is complete, the method continues by accessing a data store (such as data store 212) with the selection options at step 720. The selection options are used to filter among all facilities those matching the selection criteria of the user in step 730. Following the determination of matching facilities, the results are presented to the user in step 740 (including a listing, a mapping and any other information, as an example). Prior to this presenting step, the system may optionally present the user with a payment page, following which the results would be presented.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media having computer-executable instructions embodied thereon that, when executed by a computing device, cause the computing device to perform a method of presenting a guided care facility selection, the method comprising:
presenting a plurality of selection criteria;
receiving indicated selections of desired options;
accessing a data store with structured option information, according to the receiving step; and
filtering care facilities using the structured option information.

2. The media of claim 1, further comprising displaying the results of the filtering step.

3. The media of claim 2, wherein the display includes a list of facilities matching the indicated selections of the receiving step.

4. The media of claim 3, wherein the display includes a geographical mapping of the matching list of facilities.

5. The media of claim 4, wherein the selection criteria include a plurality of facility types.

6. The media of claim 4, wherein the selection criteria include a plurality of levels of care.

7. The media of claim 4, wherein the selection criteria include a plurality of payment methods.

8. The media of claim 4, wherein the selection criteria include location criteria.

9. The media of claim 7, further comprising providing educational definitions of each selection criteria, upon receiving an indication of a needed definition.

10. A system for presenting a guided care facility selection, the system comprising:
a computing device associated with a guided care facility selection service having one or more processors and one or more computer-storage media; and
a data store coupled with the guided care facility selection service,
wherein the guided care facility selection service:
accesses the data store;
extracts one or more facilities according to received selection criteria; and
communicates the one or more facilities extracted according to selection criteria to a user.

11. The system of claim 10, wherein the guided care facility selection service includes at least a facility type component, a level of care component, a payment method component and a location component.

12. The system of claim 10, wherein the data store and the guided care facility selection service are housed on a locally stored media.

13. The system of claim 10, wherein the data store is remote from the guided care facility selection service.
